(19) United States
(12) Patent Application Publication
(10) Pub. No.: US 2022/0266381 A1
(43) Pub. Date: Aug. 25, 2022

(54) WELDING EQUIPMENT

(71) Applicant: CONTREL TECHNOLOGY CO., LTD., TAINAN CITY (TW)

(72) Inventors: TSAN-JEN CHEN, TAINAN CITY (TW); CHUNG-I KUO, TAINAN CITY (TW); WEI-YAO HSU, TAINAN CITY (TW); CHEN-TAI CHENG, TAINAN CITY (TW); CHEN-HSUN CHOU, TAINAN CITY (TW)

(21) Appl. No.: 17/578,954

(22) Filed: Jan. 19, 2022

(30) Foreign Application Priority Data
Feb. 25, 2021 (TW) 110106590

(51) Int. Cl. B23K 26/06; B23K 26/21

(52) U.S. Cl. CPC B23K 26/0613; B23K 26/21; B23K 2103/12

(57) ABSTRACT

A welding equipment used to form two welding structures in two target locations of an electronic device is disclosed to include a laser generating device for generating a laser pulse beam, a radiation device scanning the two target locations, and an adjusting device equipped with a beam splitting system for receiving and processing the laser pulse beam. The beam splitting system separates the laser pulse beam into a reflected beam and a penetrating beam to control a radiation angle of the reflected beam and the penetrating beam, and project the reflected beam and the penetrating beam to the radiation device coaxially, so that the radiation device radiates the reflected beam and the penetrating beam coaxially to the two target locations to form the two welding structures. The radiation angle is related to relative positions of the two target locations.

### BACKGROUND OF THE INVENTION

### 1. Field of the Invention

The present invention relates to the welding equipment of electronic circuits, in particular to a welding equipment that forms multiple solder joints.

### 2. Description of the Related Art

At present, mass transfer technology is still an important issue for the transfer of micro-optoelectronic components such as mini LEDs and micro LEDs. Mass transfer usually involves obtaining multiple light-emitting elements through a transfer head, and then transferring them to the corresponding circuit board for soldering operations.

Welding methods such as reflow oven or laser welding, take the reflow furnace as an example, it is necessary to temporarily fix the circuit board with the light-emitting elements through the reflow technology. However, the size and spacing of the electrodes of mini or micro light-emitting components are very small, so the paste or liquid solder in the reflow process is not easy to control, which affects the yield. If laser welding is used, the current laser welding technology radiates a single laser beam at a time. Therefore, the entire circuit board welding operation takes a long time, which is not conducive to mass production. When multiple laser beams are used, multiple radiation devices are usually required to allow multiple radiation devices to radiate multiple laser beams one-to-one. Therefore, more hardware and cost are required, and the control is also difficulty.

### SUMMARY OF THE INVENTION

In view of the above-mentioned deficiencies, the welding equipment of the present invention radiates at least two laser beams through one laser device to simultaneously perform the welding operation of two solder joints.

The welding equipment of the present invention is used to form two welding structures in two target locations of an electronic device, comprising a laser generating device, a radiation device, and an adjusting device. The laser generating device is used to generate a laser pulse beam. The radiation device is used to scan the two target locations. The adjusting device is used to receive and process the laser pulse beam and comprises a beam splitting system. The beam splitting system is used to separate the laser pulse beam into a reflected beam and a penetrating beam to control a radiation angle of the reflected beam and the penetrating beam, and project the reflected beam and the penetrating beam to the radiation device coaxially, so that the radiation device radiates the reflected beam and the penetrating beam coaxially to the two target locations to form the two welding structures. The radiation angle is related to the relative position of the two target locations.

In this way, the welding equipment of the present invention can divide a laser pulse beam into a reflected beam and a penetrating beam through an adjusting device, and simultaneously radiate two laser spots to two target locations through a radiation device to efficiently perform welding.

The detailed composition, structure, features, or operation of the welding equipment provided by the present invention will be described in the detailed description of the subsequent implementation. However, those with ordinary knowledge in the field of the present invention should be able to understand that these detailed descriptions and the specific embodiment listed in the implementation of the present invention are only used to illustrate the present invention, and are not intended to limit the scope of the patent application of the present invention.

### BRIEF DESCRIPTION OF THE DRAWINGS

FIG. 1 is a schematic diagram of the electronic device of the present invention.

FIG. 2 is a schematic diagram of the composition block of the welding equipment of the present invention and the welding electronic device.

FIG. 3 is a schematic diagram of the electronic device in FIG. 2 from another angle, showing the positions of two laser spots and welding structures.

FIG. 4 is a schematic diagram of the electronic device in FIG. 2 from another angle, showing the positions of the two laser spots and the welding structures.

### DETAILED DESCRIPTION OF THE INVENTION

Hereinafter, the corresponding preferred embodiment is listed in conjunction with the drawings to illustrate the composition, connection, and effect of the welding equipment of the present invention. However, the composition, elements, quantity, components, size, appearance and steps of the electronic device in each of the drawings are only used to illustrate the technical features of the present invention, and not to limit the present invention.

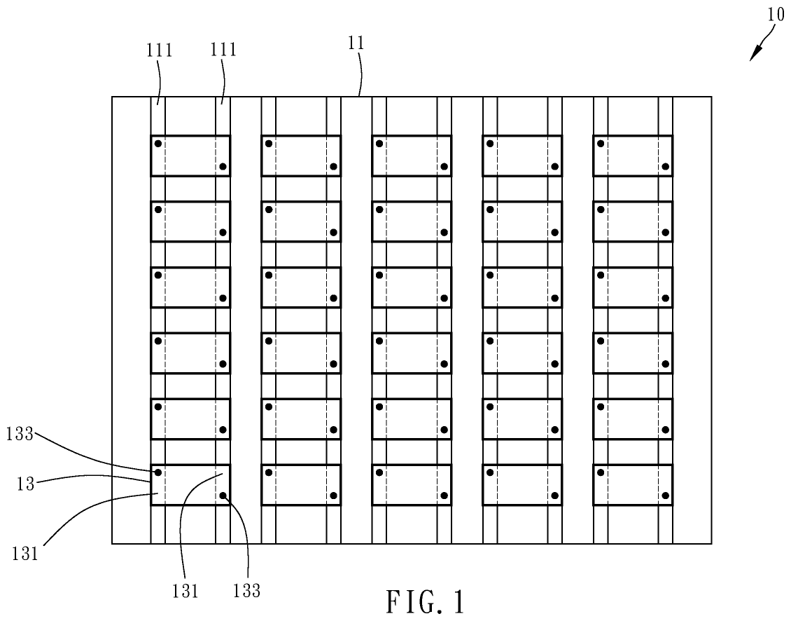

As shown in FIG. 1, the welding equipment of the present invention is used to form multiple welding structures on an electronic device 10. The electronic device 10 comprises a circuit substrate 11 and a plurality of semiconductor components 13. The circuit substrate 11 comprises a conductive circuit layer 111. Each semiconductor component 13 comprises two electrodes 131. The electrodes 131 of the semiconductor component 13 and the conductive circuit layer 111 of the circuit substrate 11 are bonded together and then welded through the welding equipment, so that a corresponding welding structure 133 is formed on each electrode 131 and the conductive circuit layer 111 in contact with the electrode 131, so that the semiconductor component 131 and the conductive circuit layer 111 are electrically coupled.

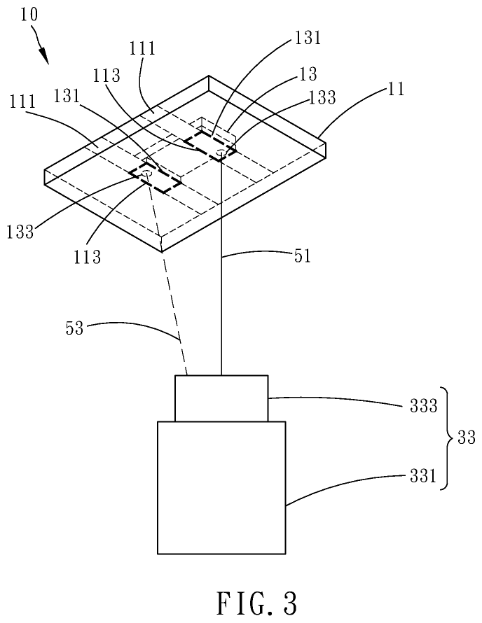

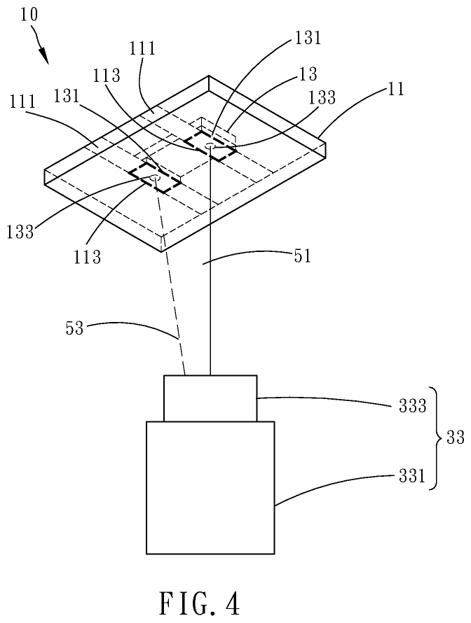

In this embodiment, the circuit substrate 11 is a glass substrate, and the semiconductor components 13 are optoelectronic components, such as light-emitting diodes. The welding equipment can identify the target locations 113 through scanning or vision system (please refer to FIG. 3 and FIG. 4). The target locations 113 are defined by the structure or marking configuration of the conductive circuit layer 111 to place the semiconductor components 13 in the corresponding locations so that the electrodes 131 of the semiconductor components 13 into the target locations 113. In other words, the number or position of target locations 113 can be changed according to the electrodes of the actual circuit and components, and is not limited to what is described in this embodiment. The range of the target locations 113 can also be smaller than the size of the electrodes 131, and not limited to electrodes 131 completely falling into the respective target locations 113.

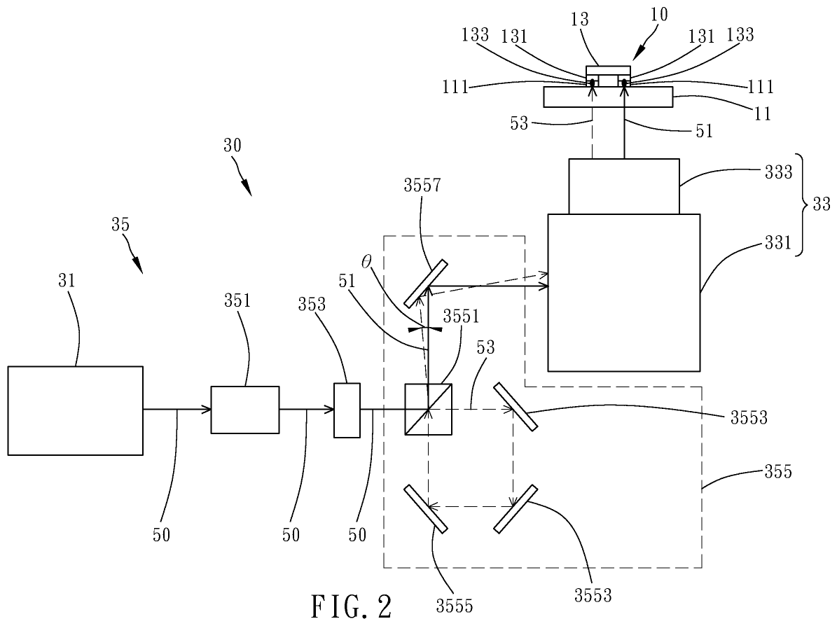

As shown in FIG. 2, the electronic device 10 in the drawing only shows one of the semiconductor components 13 and part of the circuit substrate 11 in FIG. 1. The welding equipment 30 of the present invention comprises a laser generating device 31, a radiation device 33 and an adjusting device 35.

The laser generating device 31 is used to generate a laser pulse beam 50. The laser pulse beam 50 uses, for example, a microsecond, nanosecond, picosecond or femtosecond laser to efficiently perform laser operations.

The radiation device 33 scans the target locations, and the scan can create a visual image through the scan or the vision system. The radiation device 33 comprises a scanner 331 and a flat-field focusing lens 333. The scanner 331 forms a processing field of view through the focus of the flat-field focusing lens 333. The scanner 331 can observe or scan within the field of view, and the field of view includes multiple target locations.

The adjusting device 35 receives and processes the laser pulse beam 50 to separate the laser pulse beam 50 into the reflected beam 51 and the penetrating beam 53, to control the radiation angle θ of the reflected beam 51 and the penetrating beam 53, and make the reflected beam 51 and the penetrating beam 53 be projected coaxially to the radiation device 33. Coaxiality means that the optical axes of the penetrating beam 53 and the reflected beam 51 are partially overlapped with each other.

In this embodiment, the coaxial axis is based on the reflected beam 51, and the optical path of the reflected beam 51 is designed through the central optical axis of the flat-field focusing lens 333, so that the reflected beam 51 can be roughly projected to the center of the flat-field focusing lens 333 through the radiation device 33.

In addition, the penetrating beam 53 adjusts the radiation angle θ with the optical axis of the reflected beam 51. In this way, the reflected beam 51 and the penetrating beam 53 can form two laser spots on the focusing plane through the flat-field focusing lens 333 of the radiation device 33, which are the processing points.

In this embodiment, the adjusting device 35 comprises an attenuator 351, a beam expander 353, and a beam splitting system 355. The attenuator 351 receives the laser pulse beam 50 and adjusts the light intensity by changing the polarization direction of the laser pulse beam 50. The beam expander 353 adjusts a beam size of the laser pulse beam 50. The beam splitting system 355 is used to separate the laser pulse beam 50 into the reflected beam 51 and the penetrating beam 53, to control the radiation angle θ of the reflected beam 51 and the penetrating beam 53, and project the reflected beam 51 and the penetrating beam 53 to the radiation device 33 coaxially. The present invention only needs one flat-field focusing lens 333 to roughly radiate two laser spots at different positions at the same time, so as to reduce hardware (e.g., lenses) to reduce costs.

The beam splitting system 355 comprises a beam splitter 3551, two coaxial mirrors 3553, an angle mirror 3555 and an output mirror 3557. The two coaxial mirrors 3553, the angle mirror 3555 and the output mirror 3557 can adjust the angle by a motor or an adjustment mechanism. The beam splitter 3551 separates the laser pulse beam 50 into the reflected beam 51 and the penetrating beam 53. The light intensity of the reflected beam 51 and the penetrating beam 53 are roughly the same, that is, they account for 50% of the light intensity of the laser pulse beam 50 respectively. The two coaxial mirrors 3553 are used to control the light path direction of the penetrating beam 53 so that the reflected penetrating beam 53 is coaxial with the reflected beam 51 after passing through the beam splitter 3551. The penetrating beam 53 reflected by the two coaxial mirrors 3553 radiates to the angle mirror 3555. The angle mirror 3555 is used to control the radiation angle θ. In this embodiment, the angle mirror 3555 can change the light path direction of the penetrating beam 53, so that the reflected beam 51 and the penetrating beam 53 form a radiation angle θ. In this way, the penetrating beam 53 reflected by the angle mirror 3555 passes through the beam splitter 3551 again, and radiates coaxially with the reflected beam 51 to the output mirror 3557. The output mirror 3557 reflects the coaxial reflected beam 51 and the penetrating beam 53 and radiates to the radiation device 33.

In addition, this embodiment uses the light path direction of the reflected beam 51 as a reference. Therefore, when the interval or spacing of the two target locations is known, the beam splitting system 355 only needs to adjust the two coaxial mirrors 3553 to make the reflected beam 51 and the penetrating beam 53 have a coaxial relationship, and adjust the radiation angle θ by adjusting the angle mirror 3555, so as to effectively optimize the radiation angle θ control and the correct welding.

As shown in FIG. 3, the scanner 331 of the radiation device 33 receives and reflects the reflected beam 51 and the penetrating beam 53, so that the reflected beam 51 and the penetrating beam 53 radiate outward through the flat-field focusing lens 333. In this embodiment, the reflected beam 51 radiates to the target location 113 along the focal optical axis of the flat-field focusing lens 333, and the penetrating beam 53 radiates to the target location 113 according to the radiation angle θ. The radiation angle θ is defined according to the size of the two target locations 113 to ensure that the reflected beam 51 and the penetrating beam 53 radiated from the radiation device 33 can be projected from the bottom surface of the circuit substrate 11 to the conductive circuit layer 111 correctly, so that the metal material of the conductive circuit layer 11 interacts with the metal material of the electrode 131 to form a welding structure 133. The welding structure 133 of the target location 113 on the left is close to the top, and the welding structure 133 of the target location 113 on the right is close to the bottom.

In other embodiments, such as shown in FIG. 4, the welding structures 133 both are flush. Through the welding equipment of the present invention, the position of the welding structures 133 can be changed by adjusting the radiation angle θ through the beam splitting system 355 to conform to the structure of the electrodes 131 of different light-emitting (photoelectric) components.

The reflected beam 51 and the penetrating beam 53 allow the metal material of the conductive circuit layer 11 to interact with the metal material of the electrodes 131 to allow at least one metal material to be heated and melted to form a molten pool. Subsequently, when the reflected beam 51 and the penetrating beam 53 no longer radiate to the molten pool position, the paste or liquid metal components of the molten pool solidify and the electrodes 131 of the conductive circuit layer 11 form a welding structure.

The welding equipment of the present invention separates a single laser pulse beam into two laser beams and then performs welding to two target locations at approximately the same time, so as to perform welding operations efficiently. In the mass transfer process, the process efficiency can be improved by welding the two electrode positions of the light-emitting (photoelectric) component at the same time.

Finally, it is emphasized again that the constituent elements disclosed in the previous embodiment of the present invention are only examples, and are not used to limit the scope of the present invention. The substitution or change of other equivalent components shall also be covered by the scope of patent application in the present invention.

What is claimed is:

1. A welding equipment used to form two welding structures in two target locations of an electronic device, the welding equipment comprising:
a laser generating device to generate a laser pulse beam;
a radiation device to scan said two target locations; and
an adjusting device to receive and process said laser pulse beam, said adjusting device comprising a beam splitting system, said beam splitting system being used to separate said laser pulse beam into a reflected beam and a penetrating beam to control a radiation angle of said reflected beam and said penetrating beam, and project said reflected beam and said penetrating beam to said radiation device coaxially, so that said radiation device radiates said reflected beam and said penetrating beam coaxially to said two target locations to form said two welding structures, said radiation angle being related to relative positions of said two target locations.

2. The welding equipment as claimed in claim 1, wherein said adjusting device processing said laser pulse beam comprises adjusting a polarization direction of said laser pulse beam to change an intensity of said laser pulse beam.

3. The welding equipment as claimed in claim 1, wherein said adjusting device processing said laser pulse beam comprises adjusting a beam size of said laser pulse beam.

4. The welding equipment as claimed in claim 1, wherein said beam splitting system comprises a beam splitter to generate said reflected beam and said penetrating beam.

5. The welding equipment as claimed in claim 4, wherein said beam splitting system further comprises an angle mirror to reflect said penetrating beam to control said radiation angle.

6. The welding equipment as claimed in claim 4, wherein said beam splitting system further comprises a coaxial mirror to reflect said penetrating beam so that said reflected beam and said penetrating beam are coaxial.

7. The welding equipment as claimed in claim 6, wherein said beam splitting system further comprises an angle mirror to reflect said penetrating beam to control said radiation angle.

8. The welding equipment as claimed in claim 1, wherein said beam splitting system comprises an output mirror for reflecting said reflected beam and said penetrating beam coaxially to said radiation device.

9. The welding equipment as claimed in claim 1, wherein said radiation device comprises a scanner and a flat-field focusing lens, said scanner being connected to said flat-field focusing lens and used to reflect said reflected beam and said penetrating beam, said flat-field focusing lens receiving and radiating said reflected beam and said penetrating beam reflected by said scanner.
